(19) United States
(12) Patent Application Publication
(10) Pub. No.: US 2012/0102675 A1
(43) Pub. Date: May 3, 2012

(54) Torque-adjustable hinge and portable device with the same

(75) Inventors: Chung-Yu Lee, Shulin City (TW); Chih-Kuang Chuan, Shulin City (TW)

(73) Assignee: Shin Zu Shing Co., Ltd.

(21) Appl. No.: 12/925,909

(22) Filed: Nov. 2, 2010

(51) Int. Cl. E05D 7/04

(52) U.S. Cl. 16/243

(57) ABSTRACT

A torque-adjustable hinge is mounted between a display panel and a base of a portable device and has a stationary bracket, a rotating bracket, a pintle, a torsional spring and an adjusting element. The stationary bracket is attached to the base. The rotating bracket is attached to the display panel. The pintle is attached to the rotating bracket and is mounted through the torsional spring. The torsional spring is attached to the stationary bracket and abuts against the adjusting element. By changing the height that the adjusting element protrudes above a receiving tag of the stationary bracket, the torsional spring is selectively tighter or looser wound around the pintle. Therefore, the torque generated by the hinge is adjusted without replacing any element.

### BACKGROUND OF THE INVENTION

1. Field of the Invention

The present invention relates to a torque-adjustable hinge and a portable device with the same, especially to a hinge mounted between a display panel and a base of the portable device.

2. Description of the Prior Arts

Hinges are one of the necessary elements for portable electronic devices. A conventional hinge is mounted between a display panel and a base. Different elements of the conventional hinge respectively connect to the display panel and the base to allow the display panel to pivot relative to the base. Those elements also rotate relative to each other to generate torque. The torque keeps the display panel in an open position at any desired visual angle.

However, the torque value produced by one conventional hinge is determined at the time of manufacturing by the nature of the keyed elements. For example, the torque of some conventional hinges is generated via the resilient sleeve, which means the material and the size of the resilient sleeve determine the torque value. For another example, the torque of some conventional hinge is exerted via the spring, so the coefficient of elasticity of the spring determines the torque value. The manufacturer needs to produce different keyed elements in order to have conventional hinges with different torque values. For instance, conventional hinges consisted of pintles and resilient sleeves need different resilient sleeves to produce different torque values. To prepare multiple different keyed elements increase the manufacturing cost.

To overcome the shortcomings, the present invention provides a torque-adjustable hinge to mitigate or obviate the aforementioned problems.

### SUMMARY OF THE INVENTION

The main objective of the present invention is to provide a torque-adjustable hinge without replacing any element. The torque-adjustable hinge is mounted between a display panel and a base of a portable device and has a stationary bracket, a rotating bracket, a pintle, a torsional spring and an adjusting element. The stationary bracket is attached to the base. The rotating bracket is attached to the display panel. The pintle is attached to the rotating bracket and is mounted through the torsional spring. The torsional spring is attached to the stationary bracket and abuts against the adjusting element. By changing the height that the adjusting element protrudes above a receiving tag of the stationary bracket, the torsional spring is selectively tighter or looser wound around the pintle. Therefore, the torque generated by the hinge is adjusted without replacing any element.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a torque-adjustable hinge in accordance with the present invention;

FIG. 2 is an exploded perspective view of the torque-adjustable hinge in FIG. 1;

FIG. 3 is another exploded perspective view of the torque-adjustable hinge in FIG. 1;

FIG. 4 is a side view in partial section of the torque-adjustable hinge in FIG. 1;

FIG. 5 is an end view in partial section of the torque-adjustable hinge in FIG. 1;

FIG. 6 is a perspective view of a portable device in accordance with the present invention;

FIG. 7 is an operational end view in partial section of the torque-adjustable hinge in FIG. 1;

FIG. 8 is a perspective view of another embodiment of a torque-adjustable hinge in accordance with the present invention;

FIG. 9 is an exploded perspective view of the torque-adjustable hinge in FIG. 8;

FIG. 10 is a side view in partial section of the torque-adjustable hinge in FIG. 8;

FIG. 11 is an end view in partial section of the torque-adjustable hinge in FIG. 8; and

FIG. 12 is an operational end view in partial section of the torque-adjustable hinge in FIG. 8.

### DETAILED DESCRIPTION OF THE PREFERRED EMBODIMENTS

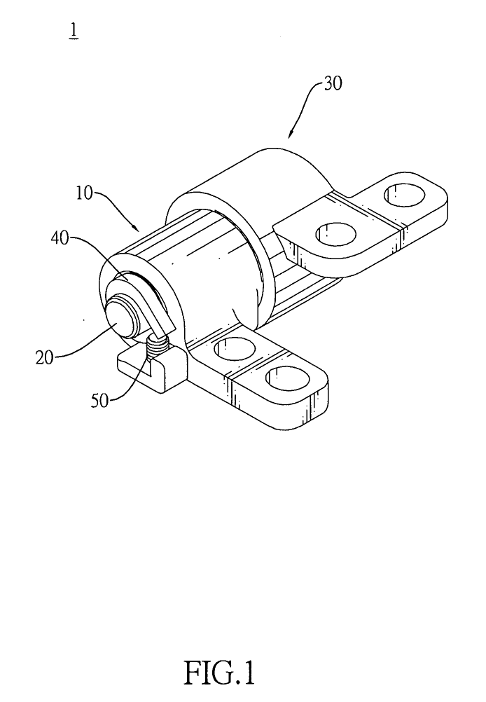

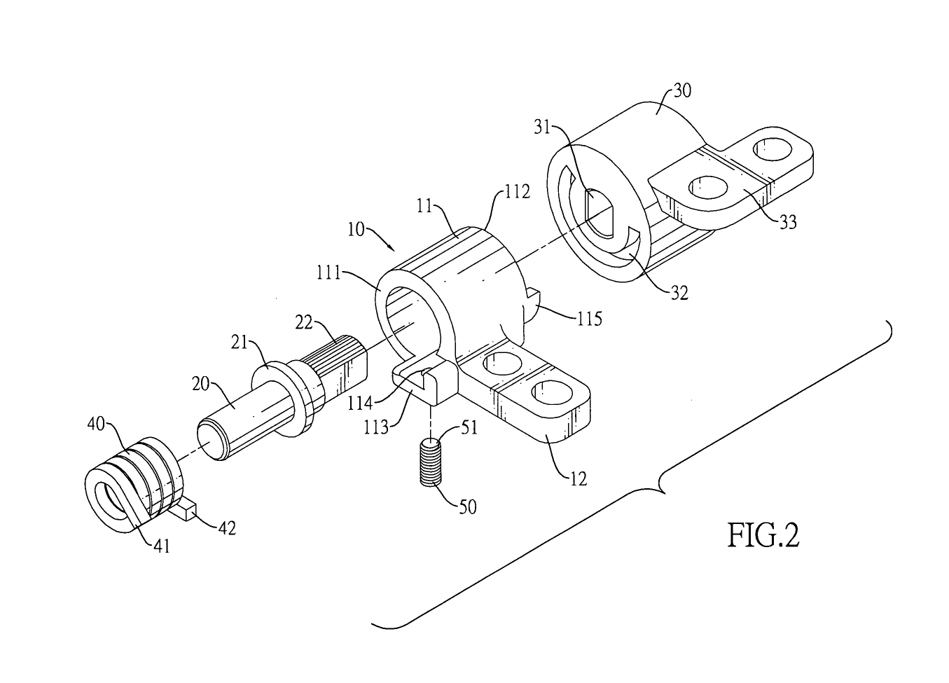

With reference to FIGS. 1 and 2, a torque-adjustable hinge 1 in accordance with the present invention comprises a stationary bracket 10, a pintle 20, a rotating bracket 30, a torsional spring 40 and an adjusting element 50.

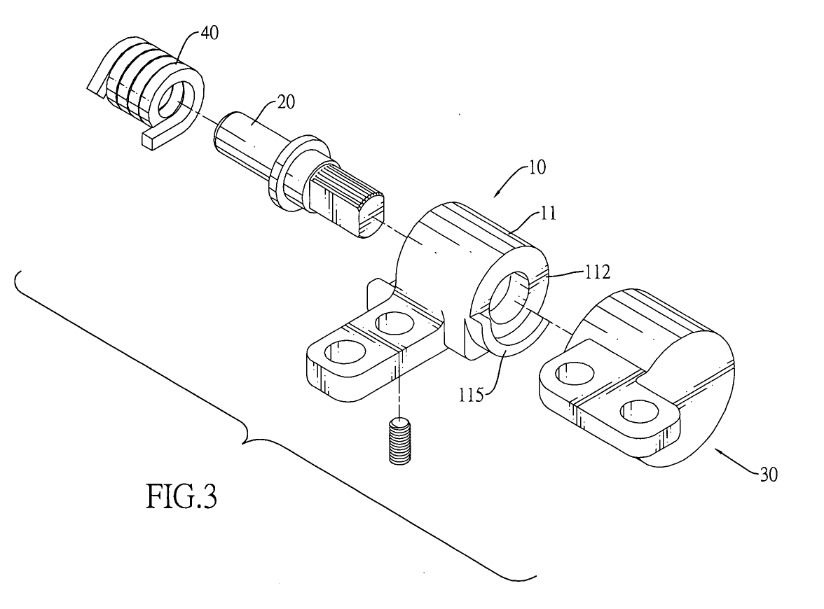

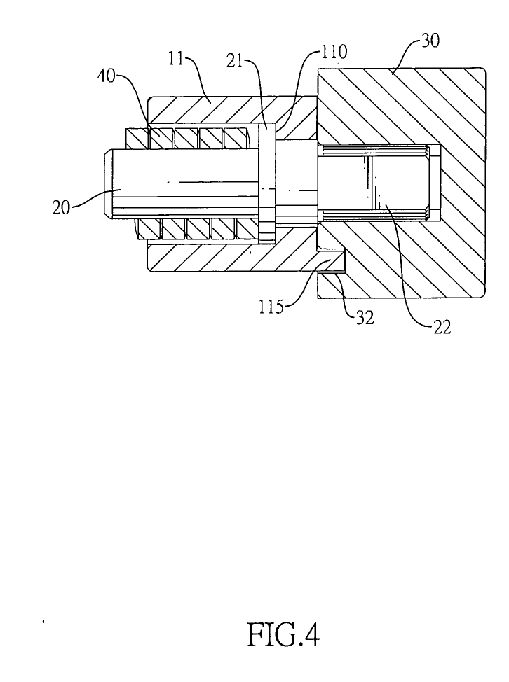

With reference to FIGS. 2 to 4, the stationary bracket 10 has a main sleeve 11 and a fastening wing 12. The main sleeve 11 has a first end 111, a second end 112, a shoulder 110, a receiving tag 113 and a stop 115. The shoulder 110 is formed on an inside wall of the main sleeve 11 near the second end 112. The receiving tag 113 is formed longitudinally at the first end 111 and has an adjusting hole 114 formed therethrough. The adjusting hole 114 may be a threaded hole. The stop 115 is formed longitudinally at the second end 112. The stationary wing 12 is formed transversely on an outside wall of the main sleeve 11.

The pintle 20 is mounted through the main sleeve 11 of the stationary bracket 10 and has an annular flange 21 and a keyed rod 22. The annular flange 21 protrudes transversely around a sidewall of the pintle 20 and abuts the shoulder 110 in the main sleeve 11. The keyed rod 22 is non-circular in cross section and is formed at an end of the pintle 20.

The rotating bracket 30 is mounted securely around the keyed rod 22 of the pintle 20 and has a keyed hole 31, an arc recess 32 and a connecting wing 33. The keyed hole 31 is non-circular, is formed at an abutting end of the rotating bracket 30 and engages the keyed rod 22. The arc recess 32 is formed at the abutting end of the rotating bracket 30 around the keyed hole 31 and receives the stop 115 of the stationary bracket 10. When the rotating bracket 30 is rotated relative to the stationary bracket 10, the stop 115 is moved in the arc recess 32 and selectively abuts against the ends of the arc recess 32 to limit the rotating angle of the rotating bracket 30. The connecting wing 33 is formed transversely on an outside wall of the rotating bracket 30.

The torsional spring 40 is wound around the pintle 20, is mounted in the main sleeve 11 of the stationary bracket 10 and has an adjusting end 41 and a fastening end 42. The adjusting end 41 corresponds to the receiving tag 113 of the stationary bracket 10. The fastening end 42 is attached securely to the stationary bracket 10.

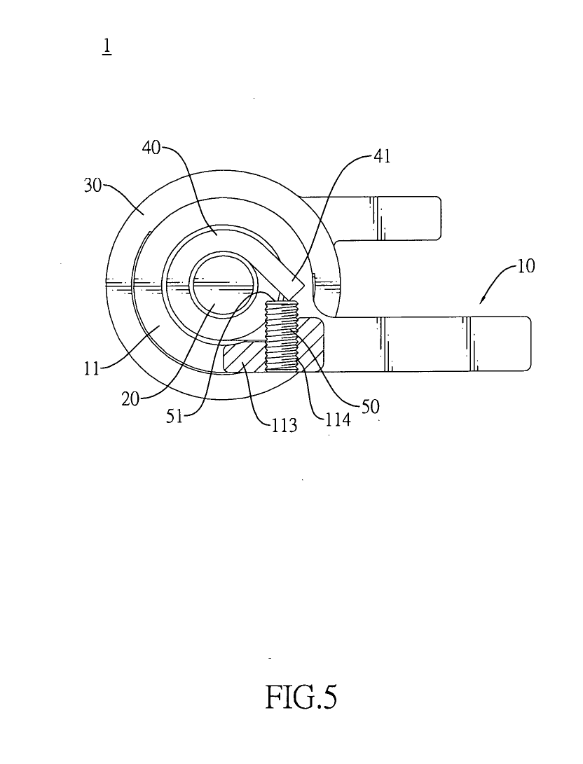

With reference to FIG. 5, the adjusting element 50 is mounted movably through the adjusting hole 114 of the receiving tag 113 and has an abutting end 51. The abutting end 51 of the adjusting element 50 abuts against the adjusting end 41 of the torsional spring 40. The adjusting element 50 may be a screw that is screwed into the adjusting hole 114 as a threaded hole.

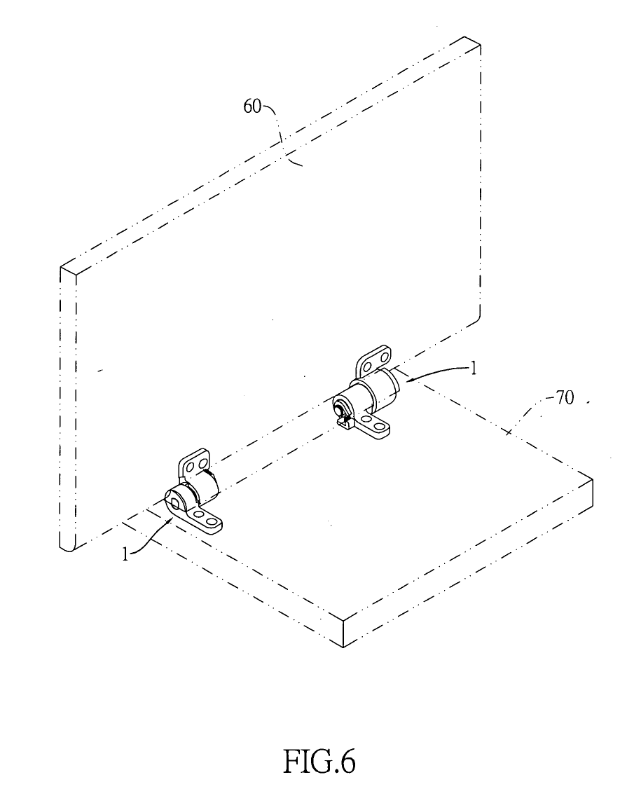

With reference to FIG. 6, a portable device in accordance with the present invention comprises a display panel 60, a base 70 and at least one torque-adjustable hinge 1 as described. The hinge 1 is mounted between the display panel 60 and the base 70 to allow the display panel 60 to pivot relative to the base 70. The connecting wing 33 of the rotating bracket 30 is attached securely to the display panel 60. The fastening wing 12 of the stationary bracket 10 is attached securely to the base 70. When the display panel 60 is pivoted relative to the base 70, the rotating bracket 30 is rotated relative to the stationary bracket 10.

With reference to FIGS. 5 and 6, when the rotating bracket 30 is rotated relative to the stationary bracket 10, the pintle 20 is rotated relative to the torsional spring 40. Because the relative rotation causes the pintle 20 to rub against the torsional spring 40 and generate torque, the torque holds the display panel 60 to stop at any desired visual angle.

Furthermore, the winding direction of the torsional spring 40 can correspond to the rotating direction of the rotating bracket 30. When the display panel 60 is pivoted to an open position, i.e. rotated counterclockwise as shown in FIG. 5, the pintle 20 is rotated to loosen the torsional spring 40 so that the display panel 60 is rotated to an open position with a lower magnitude of torque. When the display panel 60 is pivoted to a closed position, i.e. rotated clockwise as shown in FIG. 5, the pintle 20 is rotated to tighten the torsional spring 40 so the display panel 60 is pivoted to a closed position with a higher magnitude of torque. Therefore, the user opens the display panel 60 quickly with smaller force, and the user also closes the display panel 60 slower with larger force to prevent the display panel 60 from hitting the base 70.

When the torque value generated by the hinge 1 needs to be changed, the manufacturer only needs to change the height that the adjusting element 50 protrudes above the receiving tag 113 to adjust the torque.

With reference to FIG. 5, when the height that the adjusting element 50 protrudes above the receiving tab 113 is shorter, the torsional spring 40 is wound tighter around the pintle 20 so that the friction between the torsional spring 40 and the pintle 20 is larger. Therefore, the torque generated by the hinge 1 is also larger. In cooperation with the different forces provided in the open-and-close process, the torque exerted during the opening process is about 2 kilograms and the torque exerted during the closing process is about 8 kilograms.

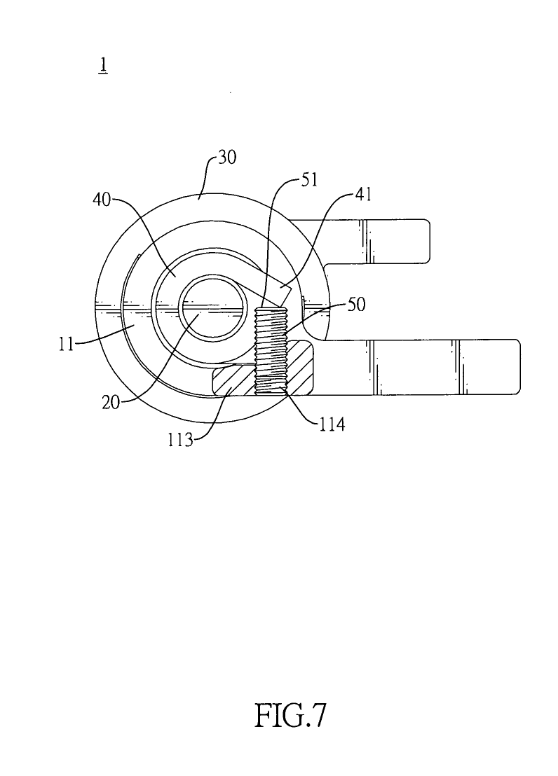

With reference to FIG. 7, when the height that the adjusting element 50 protrudes above the receiving tab 113 is longer, the torsional spring 40 is wound looser around the pintle 20 so that the friction between the torsional spring 40 and the pintle 20 is smaller. Therefore, the torque generated by the hinge 1 is also smaller. In cooperation with the different external forces requirement in the open-and-close process, the torque exerted during the opening process is about 1.5 to 1.8 kilograms and the torque exerted during the closing process is about 4 to 7.5 kilograms.

Thus, the main advantage of the hinge 1 is to provide different torque values without replacing any element. The manufacturer only needs to adjust the position of the adjusting element 50. The torque values disclosed above are illustrative only. That is, the display panel can be hinged to rotate between open and closed condition due to different torque values generated by the hinge, whether the adjusting element 50 is adopted or not.

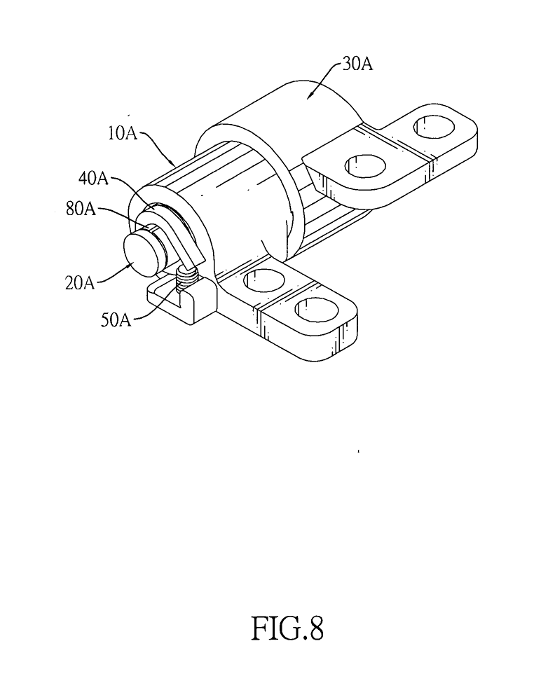

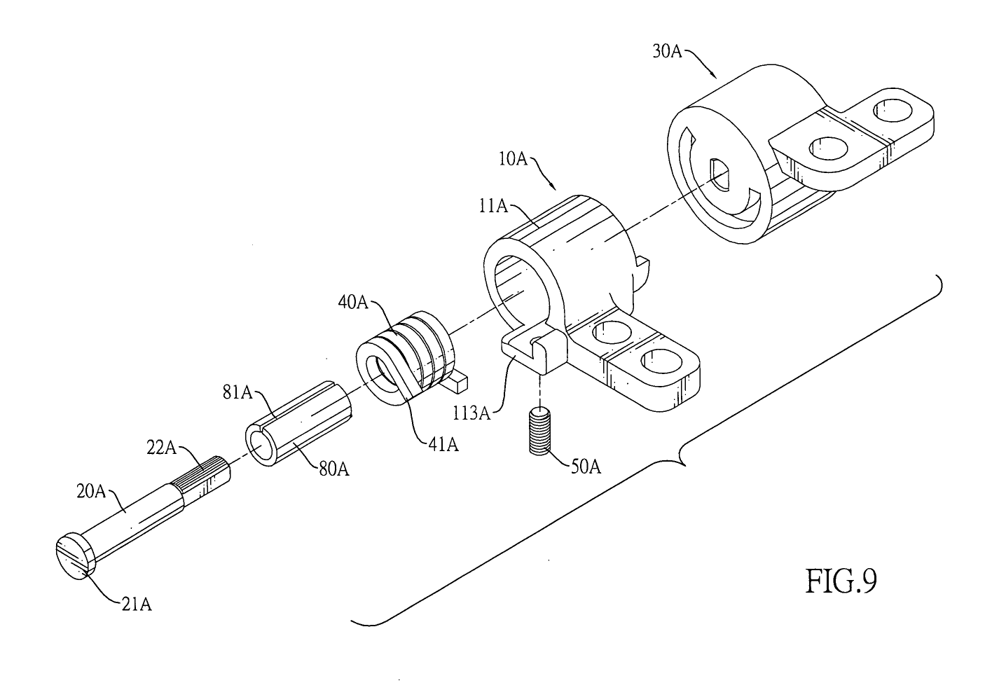

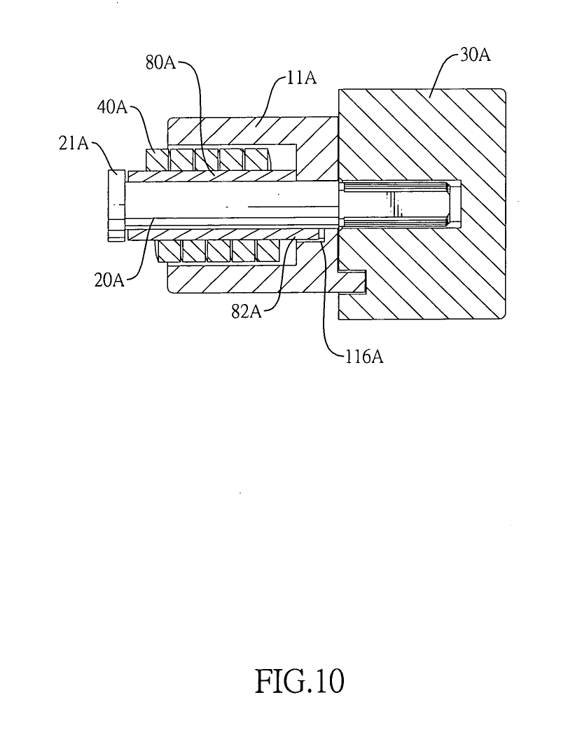

In another preferred embodiment as shown in FIGS. 8 to 10, the hinge in accordance with the present invention further comprises a resilient sleeve 80A. The resilient sleeve 80A is mounted around the pintle 20A, is mounted in the torsional spring 40A and has a longitudinal slit 81A and a keyed protrusion 82A. The longitudinal slit 81A is formed through a sidewall of the resilient sleeve 80A to allow the resilient sleeve 80A to expand. The keyed protrusion 82A is formed at an end of the resilient sleeve 80A. The main sleeve 11A of the stationary bracket 10A has a keyed recess 116A formed on the shoulder 110A. The keyed protrusion 82A engages the keyed recess 116A to mount the resilient sleeve 80A securely in the main sleeve 11A. The annular flange 21A and the keyed rod 22A are formed at opposite ends of the pintle 20A so that the resilient sleeve 80A is mounted between the rotating bracket 30A and the annular flange 21A. Then the annular flange 21A keeps the resilient sleeve 80A from escaping axially from the pintle 20A.

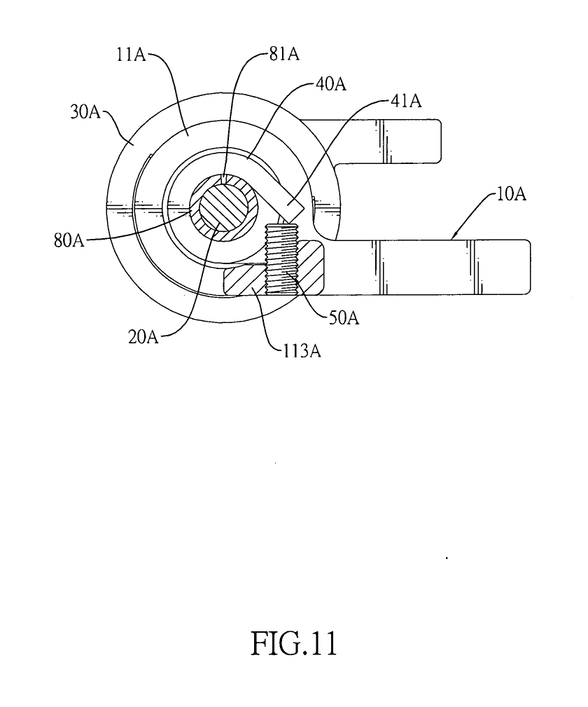

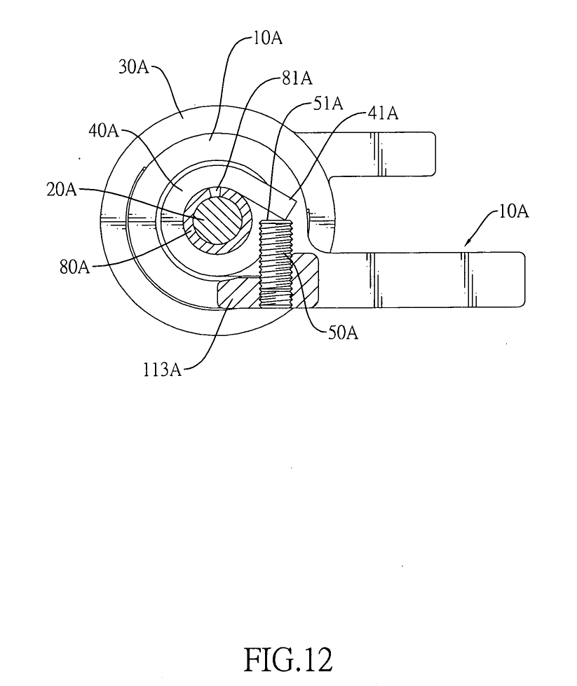

With reference to FIGS. 11 and 12, when the torque value of the hinge needs to be changed, the manufacturer can change the height that the adjusting element 50a protrudes above the receiving tag 113A to adjust the torque. With reference to FIG. 11, when the height that the adjusting element 50A protrudes above the receiving tab 113A is shorter, the torsional spring 40A is wound tighter around the resilient sleeve 80A. Then the resilient sleeve 80A is mounted tighter around the pintle 20A so that the friction between the resilient sleeve 80A and the pintle 20A is larger. Therefore, the torque generated by the hinge is also larger.

With reference to FIG. 12, when the height that the adjusting element 50A protrudes above the receiving tab 113A is longer, the torsional spring 40A is wound looser around the resilient sleeve 80A. Then the resilient sleeve 80A is mounted looser around the pintle 20A and the longitudinal slit 81A is expanded so that the friction between the resilient sleeve 80A and the pintle 20A is smaller. Therefore, the torque generated by the hinge is also smaller.

Thus, the hinge as described also generates different torque values without replacing any element. The manufacturer only needs to adjust the position of the adjusting element 50A.

In the first preferred embodiment as shown in FIGS. 1 to 7, the hinge 1 generates different magnitudes of external force in the open-and-close process as the torsional spring 40 directly rubs against the pintle 20. Therefore, as the adjustment of the adjusting element 50, torque value in opening or closing the display panel varies so as to achieve the function that a user can easily and quickly open the display panel with smaller force and close the display panel slower with much more force to prevent the display panel from hitting the base. However, in the second preferred embodiment as shown in FIGS. 8 to 12 the hinge generates the same magnitude of external force in the open-and-close process because the resilient sleeve 80A is mounted between the torsional spring 40A and the pintle 20A. That is to say, the second embodiment of the present invention can also adjust the torque value, but the torque value in the opening or closing the display panel remains the same value.

Please note that in the first preferred embodiment, the stationary bracket 10 has the main sleeve 11 to secure the fastening end 42 of the torsional spring 40. However, even without the main sleeve 11, the stationary bracket 10 can directly attach to the fastening end 42 of the torsional spring 40 without altering the main feature of the present invention. The stationary bracket 10 can be formed as other structures and is not limited as aforementioned.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A torque-adjustable hinge comprising:
a pintle;
a rotating bracket mounted securely on the pintle;
a torsional spring mounted around the pintle and has an adjusting end and a fastening end;
a stationary bracket attached securely to the fastening end of the torsional spring and having a receiving tag formed thereon, corresponding to the adjusting end of the torsional spring and having an adjusting hole formed therethrough; and
an adjusting element mounted movably through the adjusting hole of the receiving tag and having an abutting end abutting against the adjusting end of the torsional spring.

2. The torque-adjustable hinge as claimed in claim 1, wherein
the stationary bracket has a main sleeve mounted around the torsional spring and having a first end and a second end; and
the receiving tag of the stationary bracket is formed at the first end of the main sleeve.

3. The torque-adjustable hinge as claimed in claim 2, wherein
the second end of the main sleeve corresponds to the rotating bracket;
the rotating bracket has an arc recess formed at an abutting end of the rotating bracket; and
the stationary bracket has a stop formed longitudinally at the second end of the main sleeve and mounted rotatably in the arc recess of the rotating bracket.

4. The torque-adjustable hinge as claimed in claim 1, wherein
the pintle has a non-circular keyed rod formed at an end of the pintle; and
the rotating bracket has a non-circular keyed hole formed at an abutting end of the rotating bracket and engages the keyed rod of the pintle.

5. The torque-adjustable hinge as claimed in claim 3, wherein
the pintle has a non-circular keyed rod formed at an end of the pintle; and
the rotating bracket has a non-circular keyed hole formed at the abutting end of the rotating bracket and engages the keyed rod of the pintle.

6. The torque-adjustable hinge as claimed in claim 1, wherein the pintle has an annular flange protruding transversely around a sidewall of the pintle.

7. The torque-adjustable hinge as claimed in claim 2, wherein
the main sleeve has a shoulder formed on an inside wall of the main sleeve; and
the pintle has an annular flange protruding transversely around a sidewall of the pintle and abutting the shoulder in the main sleeve.

8. The torque-adjustable hinge as claimed in claim 3, wherein
the main sleeve has a shoulder formed on an inside wall of the main sleeve; and
the pintle has an annular flange protruding transversely around a sidewall of the pintle and abutting the shoulder in the main sleeve.

9. The torque-adjustable hinge as claimed in claim 5, wherein
the main sleeve has a shoulder formed on an inside wall of the main sleeve; and
the pintle has an annular flange protruding transversely around a sidewall of the pintle and abutting the shoulder in the main sleeve.

10. The torque-adjustable hinge as claimed in claim 1 further comprising a resilient sleeve mounted around the pintle and mounted in the torsional spring and having a longitudinal slit formed through a sidewall of the resilient sleeve.

11. The torque-adjustable hinge as claimed in claim 10, wherein
the stationary bracket has a main sleeve mounted around the torsional spring and having
a first end;
a second end; and
a shoulder formed on an inside wall of the main sleeve; and
a keyed recess formed in the shoulder;
the receiving tag of the stationary bracket is formed at the first end of the main sleeve; and
the resilient sleeve has a keyed protrusion formed at an end of the resilient sleeve and engaging the keyed recess.

12. The torque-adjustable hinge as claimed in claim 8, wherein
the pintle has an annular flange and a keyed rod respectively formed at opposite ends of the pintle, and the keyed rod attached securely to the rotating bracket; and
the resilient sleeve mounted between the annular flange and the rotating bracket.

13. The torque-adjustable hinge as claimed in claim 11, wherein
the pintle has an annular flange and a keyed rod respectively formed at opposite ends of the pintle, and the keyed rod attached securely to the rotating bracket; and
the resilient sleeve mounted between the annular flange and the rotating bracket.

14. The torque-adjustable hinge as claimed in claim 12, wherein
the keyed rod of the pintle is a non-circular; and
the rotating bracket has a non-circular keyed hole formed at an abutting end of the rotating bracket and engages the keyed rod of the pintle.

15. The torque-adjustable hinge as claimed in claim 13, wherein
the keyed rod of the pintle is a non-circular; and
the rotating bracket has a non-circular keyed hole formed at an abutting end of the rotating bracket and engages the keyed rod of the pintle.

16. The torque-adjustable hinge as claimed in claim 11, wherein
the second end of the main sleeve corresponds to the rotating bracket;
the rotating bracket has an arc recess formed at an abutting end of the rotating bracket; and
the stationary bracket has a stop formed longitudinally at the second end of the main sleeve and mounted rotatably in the arc recess of the rotating bracket.

17. A portable device with at least one torque-adjustable hinge as claimed in claim 1 comprising:
a display panel attached securely to the rotating bracket; and
a base attached securely to the stationary bracket.
